(19) United States
(12) Patent Application Publication
(10) Pub. No.: US 2021/0068393 A1
(43) Pub. Date: Mar. 11, 2021

(54) Nematode Control System and Method

(71) Applicant: Thomas N. Tremblay, JR., Miami, FL (US)

(72) Inventor: Thomas N. Tremblay, JR., Miami, FL (US)

(21) Appl. No.: 16/561,215

(22) Filed: Sep. 5, 2019

(51) Int. Cl. A01N 31/02; A01N 31/16; A01N 25/34

(52) U.S. Cl. CPC A01N 31/02; A01N 25/34; A01N 31/16

(57) ABSTRACT

A solid tablet form of nematode control composition includes as active ingredients one or both of about 7.5% geraniol by weight and about 0.5% eugenol by weight, with the active ingredients watered into a turf area to be treated by use of a hose-end application device.

### FIELD OF THE DISCLOSURE

The invention relates generally to a system and method for the control of nematodes in turf, and more specifically to a solid tablet composition including about 7.5% geraniol by weight and about 0.5% eugenol by weight.

### BACKGROUND

Nematodes (roundworms) may cause significant damage to turf, e.g., on a golf course. Accordingly, considerable time and money has been spent developing nematode control substances and methods. Compositions for controlling nematodes are available in a liquid form, and typically are sprayed on an area of turf to be treated. Such liquid compositions may include one or more of geraniol and eugenol as active ingredients. However, no such compositions are available in solid tablet form, for watering into a desired treatment area. Thus, an additional or improved method for controlling nematodes including a solid tablet form of treating composition is desirable.

### SUMMARY

The present disclosure provides systems and methods for controlling nematodes in an area of turf. In one exemplary embodiment, a composition for nematode control includes one or more of geraniol and eugenol as active ingredients, and the composition is provided in a solid tablet form. Using a hose-end application device, the composition for nematode control may be watered into an area of turf to be treated. In another exemplary embodiment, a nematode control composition includes about 7.5% geraniol by weight. In another exemplary embodiment, a nematode control composition includes about 0.5% eugenol by weight. In another exemplary embodiment, the nematode control composition includes about 7.5% geraniol by weight and about 0.5% eugenol by weight.

Other benefits and advantages of the present disclosure will be appreciated from the following detailed description.

### DETAILED DESCRIPTION

Embodiments of the invention and various alternatives are described. Those skilled in the art will recognize, given the teachings herein, that numerous alternatives and equivalents exist which do not depart from the invention. It is therefore intended that the invention not be limited by the description set forth herein or below.

One or more specific embodiments of the system and method will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Further, for clarity and convenience only, and without limitation, the disclosure sets forth exemplary representations of only certain aspects of events and/or circumstances related to this disclosure. Those skilled in the art will recognize, given the teachings herein, additional such aspects, events and/or circumstances related to this disclosure, e.g., additional elements of the devices described; events occurring related to nematode control; etc. Such aspects related to this disclosure do not depart from the invention, and it is therefore intended that the invention not be limited by the certain aspects set forth of the events and circumstances related to this disclosure.

In accordance with an exemplary embodiment, a nematode control composition is provided in solid tablet form. An area of turf may be treated for the control of nematodes by watering the solid tablet composition into the turf area. A device such as a hose-end application device may be used to water-in the nematode control composition.

Control of nematodes includes eradicating all or a portion of the nematodes found in a particular area of turf that is treated.

In one embodiment, the solid tablet form of composition includes about 7.5% geraniol by weight. In another embodiment, the solid tablet form of composition includes about 0.5% of eugenol by weight. In another embodiment, the solid tablet form of composition includes about 7.5% geraniol by weight and about 0.5% of eugenol by weight. Other active ingredients for the control of nematodes may be used.

The solid tablet form of composition may include one or more of the following: water, monopalmitin, palm oil, urea, soapbark, and sodium benzoate.

In one embodiment, the solid tablet form of composition for the control of nematodes may have a weight of about 100 grams per tablet. Such a tablet may be used to treat approximately 3000 square feet of turf with a weekly application. Of course, other tablet sizes and application rates may be used depending upon the circumstances involved in a particular application. The nematode control solid tablet will dissolve using a hose-end sprayer at different rates depending upon factors such as water pressure, chemistry, temperature and water flow rate.

It should be understood that the foregoing description is only illustrative of the invention. Various alternatives and modifications can be devised by those skilled in the art having the benefit of this disclosure, without departing from the invention. Accordingly, the invention is intended to embrace all such alternatives, modifications and variances.

Certain exemplary embodiments of the disclosure may be described. Of course, the embodiments may be modified in form and content, and are not exhaustive, i.e., additional aspects of the disclosure, as well as additional embodiments, will be understood and may be set forth in view of the description herein. Further, while the invention may be susceptible to various modifications and alternative forms, specific embodiments have been shown by way of example and will be described in detail herein. However, it should be understood that the invention is not intended to be limited to the particular forms disclosed. Rather, the invention is to cover all modifications, equivalents and alternatives falling within the spirit and scope of the invention.

1. A nematode control composition consisting of about 7.5% geraniol by weight; about 0.5% eugenol by weight; and water, monopalmitin, palm oil, urea, soapbark, and sodium benzoate; wherein the composition is in solid tablet form.

2. (canceled)

3. The nematode control composition of claim 1, wherein the solid tablet form of composition weighs about 100 grams per tablet.

4. A method for controlling nematodes including the steps of:
(a) providing a solid tablet form of composition consisting of about 7.5% geraniol by weight; about 0.5% eugenol by weight; water, monopalmitin, palm oil, urea, soapbark, and sodium benzoate; and
(b) using a hose-end application device to water the composition into an area of turf to be treated.

5. The method of claim 4 wherein the solid tablet form of composition weighs about 100 grams per tablet.

6. The method of claim 5 wherein one solid tablet form of composition is used to treat about 3000 square feet of turf area.

7. The method of claim 6, wherein a solid tablet form of composition is watered into the turf area weekly.
